(19) United States
(12) Patent Application Publication
(10) Pub. No.: US 2004/0107197 A1
(43) Pub. Date: Jun. 3, 2004

(54) System, method and user interface allowing customized portfolio management

(76) Inventors: Yu Yong Shen, Taipei (TW); Edwin D. Liou, Taipei (TW); Lup Cheong Patrick Hung, Hsin-Chu (TW); Jeffrey Liou, Hsin-Chu (TW); Chun-Cho Chen, Hsin-Chu (TW); Yu-Jen Chen, Taipei (TW); Ming-Hsin Thomas Chen, Hsin-Chu (TW)

Correspondence Address: SLATER & MATSIL, L.L.P., 17950 PRESTON RD, SUITE 1000, DALLAS, TX, 75252-5793, US

(21) Appl. No.: 10/307,180

(22) Filed: Nov. 29, 2002

(51) Int. Cl. G06F 17/30

(52) U.S. Cl. 707/9

(57) ABSTRACT

A system for customized portfolio management. A method and user interface is provided accordingly, allowing customized portfolio management. In an exemplary embodiment the system comprises a document metadata database storing a plurality of documents and meta information thereof, a management server programmed to rule engine, search, security engine and notification engines, and a Web server providing an interactive website displaying documents, allowing creation of a customized portfolio. The customized portfolio management system provides notification on the website, apprising users of changes in the status of their documents.

### BACKGROUND OF THE INVENTION

1. Field of the Invention

The present invention relates to web-based document management, and in particular to a system, a method, and user interface allowing customizing a portfolio of technology documents regarding IC design.

2. Description of the Related Art

The design of an integrated circuit (IC) typically includes the production of a schematic representation showing the circuit elements (termed cells) for each functional unit of the IC and the interconnections between the elements. The schematic is translated into a physical layout that is a geometric representation of the circuit, composed of polygons and interconnecting paths. The layout specifies the position and relative dimensions of the layers of materials deposited on a silicon wafer to form the circuit elements and interconnections.

In addition to the correspondence between a schematic and the physical layout, it is also necessary that the integrated circuit design be consistent with the fabrication process, e.g. technology, equipment, and capability, The IC fabrication process at a given foundry may differ from that at other foundries. For example, a more advanced fabrication facility may fabricate an IC with interconnections having narrower line widths and smaller spaces between adjacent layers than a less advanced facility. Depending on the foundry's fabrication technologies and techniques, and the materials used, different physical geometric configuration constraints apply. These constraints are commonly referred to as “design rules.” Design rules include, for example, dimensional specifications for the layout of a design, such as minimum spacing between transistors, minimum separation between conductors to prevent shorting, minimum metal width, contact size and spacing between the contacts, and minimum transistor length and width. Therefore, there is a need, in the process' early stages, for IC designers to access technology documents regarding foundry fabrication.

Presently, IC fabrication is highly developed and a semiconductor foundry may provide their customers with various technology choices and process options. Foundries usually provide numerous technology documents with respect to several geometries, e.g. 0.35 μm, 0.25 μm, 0.22 μm, 0.18 μm, and 0.15 μm, and various products such as logic products, MS/RF, embedded flash, and so on. One feature of the technology documents is that some may subordinate others. Thus, when a document is amended, the related documents must also be updated correspondingly, to prevent version conflict.

Currently, technology documents are delivered in several ways. One way assigns customer service representatives to monitor documents status for customers and manually forward documents upon request.

The second way entails a foundry providing the latest set, i.e. synchronized version, of all design related documents online for customer access. A disadvantage is that design customers have to spend time determining which documents related to their design have been changed. Also, there is no further information provided for the customers to conduct evaluation of the impact on the original or subsequent design when technology documents have been updated.

Using the third method, a foundry provides the latest technology documents online without version synchronization. The same disadvantages exist as the previous method, in that customers spend time determining which documents relating to their design have been updated. Moreover, because the versions of the documents are not synchronized, the customers have to evaluate the compatibility of the related documents between versions. Conflicting versions can cost a lot of time and money to fix, and even worse, delay new product availability on the market.

### SUMMARY OF THE INVENTION

Accordingly, an aspect of the invention provides a system and method allowing IC designers to easily create their own portfolios of selected technology documents regarding their design.

Another aspect of the invention provides web-based user interface allowing IC designers to easily maintain and monitor their own portfolios of technology documents.

Still another aspect of the invention provides customized and verified design related documents, with respect to a specific technology, for IC designers.

Still another aspect of the invention provides a notification mechanism to indicate document status, such as which documents have been updated and version compatibility thereof.

The present invention, therefore, provides a customized portfolio management system, comprising: a document metadata database storing classified documents and meta information thereof, a document repository management server programmed as security engine, rule engine, search engine and notification engines, and a Web server providing an interactive website displaying the classified documents from which a terminal user can compile a customized portfolio.

The security engine authenticates user identification when a terminal user logon the website. The search engine searches the document metadata database according selection on the website to create the customized portfolio. The rule engine identifies document status in the document metadata database and the notification engine monitors the status of the customized portfolio, sending notification when the status changes.

In addition, the management server further provides a sharing engine allowing users to share a customized portfolio with other users with pre-defined privileges.

Moreover, a method for customized portfolio management is provided in accordance with the invention. One feature of the method is provision of a website that includes a browsable catalog of documents and allows users to create their own customized portfolio by selecting required documents. Another feature allows monitoring of document status in the customized portfolio by sending notifications when the status of any document in the portfolio is changed.

Accordingly, a service for online creation, maintenance, administration and monitoring of a customized portfolio of technology documents is achieved.

In addition, web-based user interface is also provided with indicators to notify portfolio owners of the document status changes in the portfolio.

A detailed description is given in the following embodiments with reference to the accompanying drawings. All objects, features, and advantages of the present invention become apparent in the following description.

### BRIEF DESCRIPTION OF THE DRAWINGS

The present invention can be more fully understood by reading the subsequent detailed description and examples with references made to the accompanying drawings, wherein:

FIG. 1 illustrates a general architecture of a customized portfolio management system that operates in accordance with the present invention;

FIGS. 2A to 2E illustrate preferred user interface allowing creating a customized portfolio in accordance with the present invention;

FIGS. 3A to 3C illustrate preferred user interface allowing sharing a portfolio in accordance with the present invention;

FIGS. 4A to 4D illustrate preferred user interface allowing monitoring, managing and creating a customized portfolio in accordance with the present invention;

FIGS. 5A to 5C illustrate preferred user interface allowing document version monitoring, updating, and document deleting in accordance with the present invention;

FIGS. 6A to 6C illustrate preferred user interface allowing authorized users to download a technology fact sheet in accordance with the present invention;

FIGS. 7A to 7C illustrate preferred user interface allowing authorized users to download a customized portfolio in accordance with the present invention; and

FIG. 8 illustrates a method flow to provide customized portfolio management in accordance with the present invention.

### DETAILED DESCRIPTION OF THE INVENTION

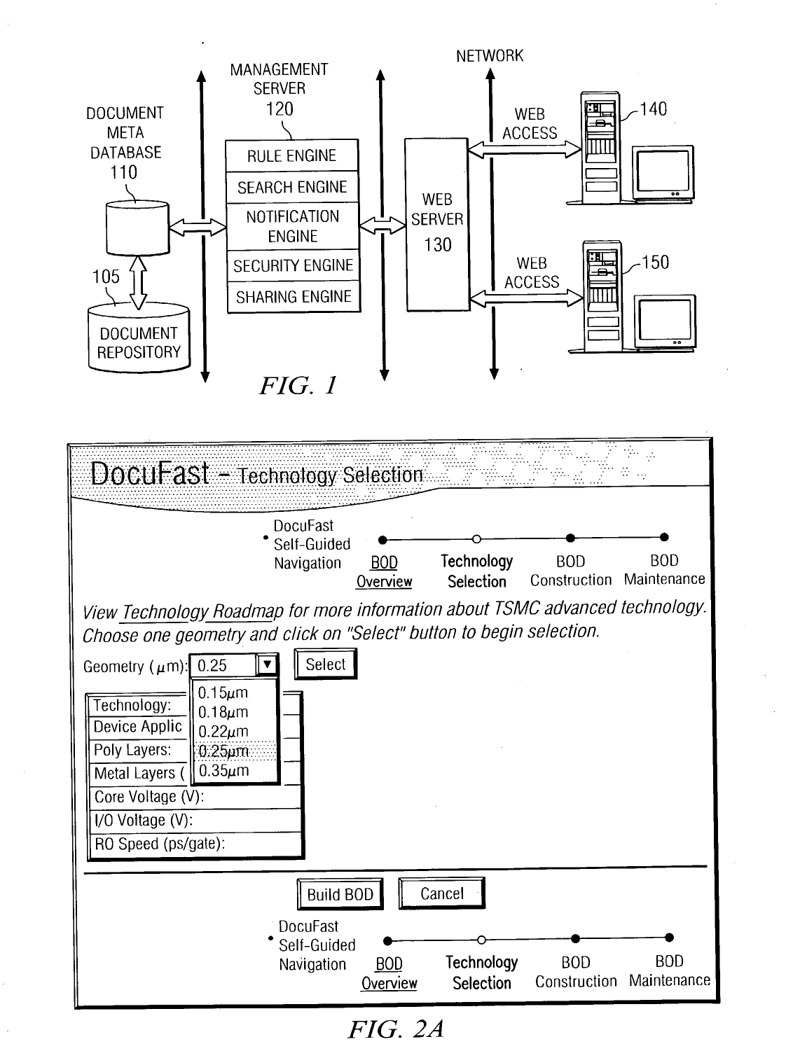

FIG. 1 illustrates the general architecture of a customized portfolio management system 100 that operates in accordance with the present invention. A service allowing customized and monitoring design portfolio provided by a semiconductor foundry is exemplified accordingly. A customized portfolio management system 100 includes a document metadata database 110, a document repository management server 120, and a Web server 130. All the technology documents created by a semiconductor foundry can be stored in a repository database 105. The technology documents are then classified and stored in the meta document database 110 and meta information of the classified documents is also stored in the meta document database 110 accordingly. Preferably, the technology documents are classified based on geometry and product application.

The management server 120 is linked to the document metadata database 110, containing a security engine module, a rule engine module, a search engine module, a notification engine module and a sharing engine module. The Web server 130 is linked to the management server 120, which provides a website and user interface (UI) for terminal design customers/users 140 or 150 to link to via network and interactively access via a Web browser. Terminal customers/users 140 or 150 are, preferably, IC design customers authorized by the foundry to access the website.

The Web server 130 provides a site and specific user interface with specific functionalities allowing terminal customers to build, monitor and maintain their own design portfolio from numerous technology documents. In operation, an authorized IC designer 140 or 150 accesses the website provided by the Web server 130 using a standard Web browser to communicate with the Web server 130 of the user's site 140 or 150. The security engine will authenticate the identification of terminal users comparing with predetermined customer information provided by the foundry. For a new design, i.e. a new semiconductor product, the website provides an interactive user interface allowing the authorized designer to create a new and exclusive portfolio for the new design. The management server 120 accesses the document metadata database 110 according to the request, displaying an overview of the technology documents on the user interface for selection.

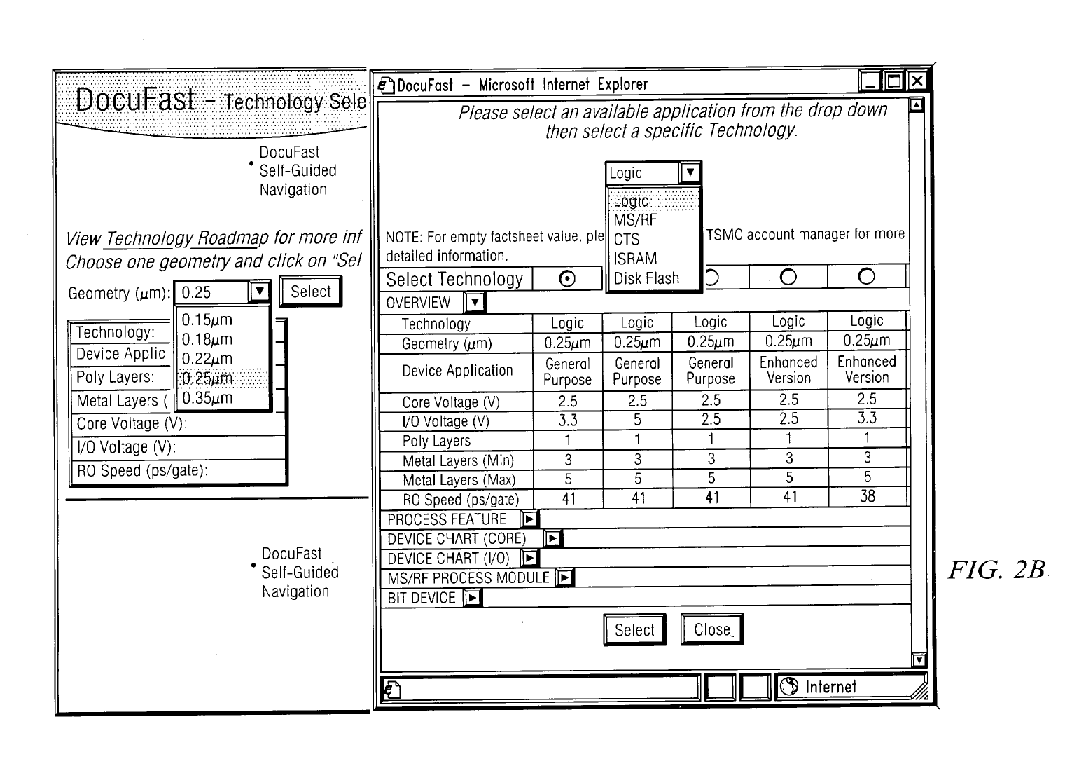

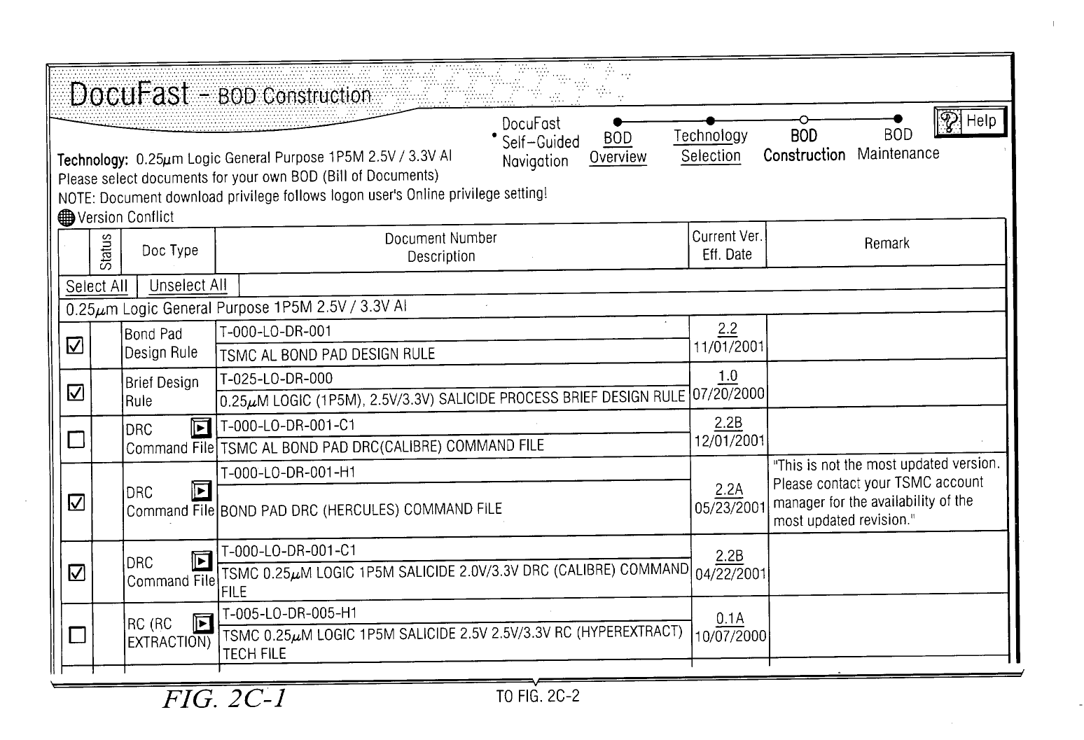

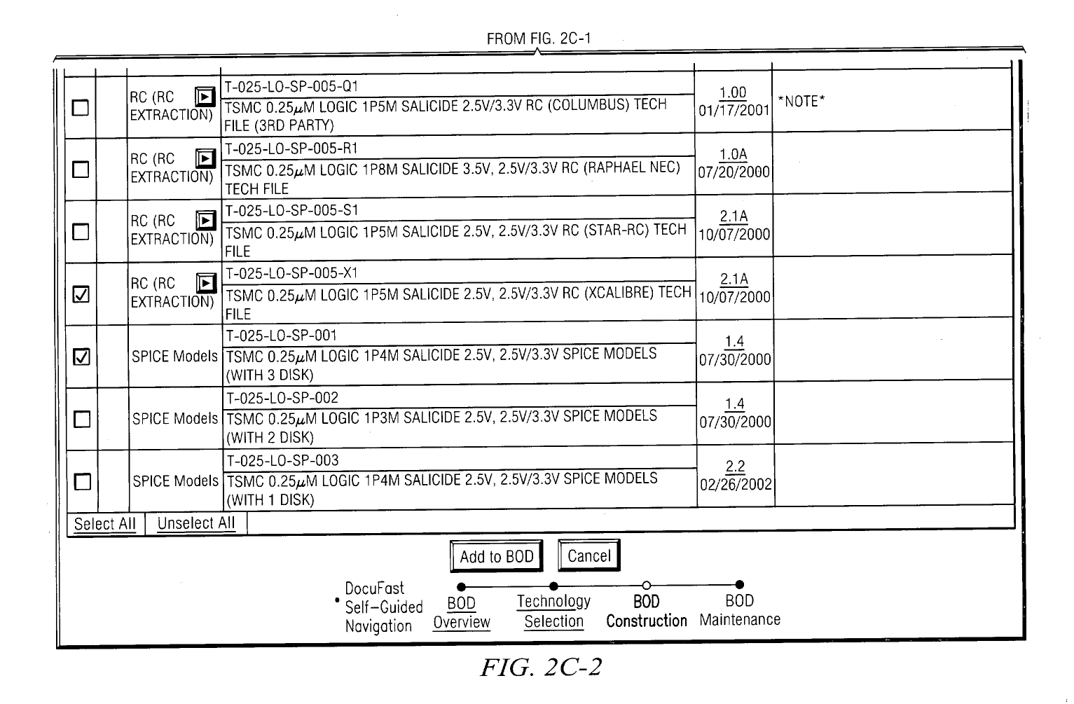

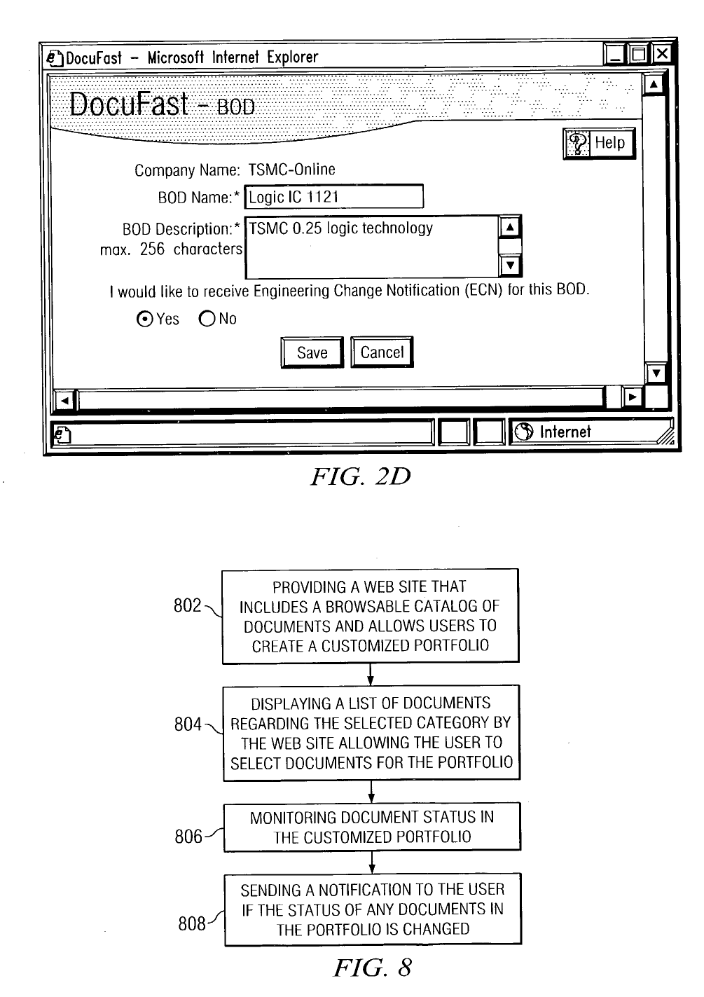

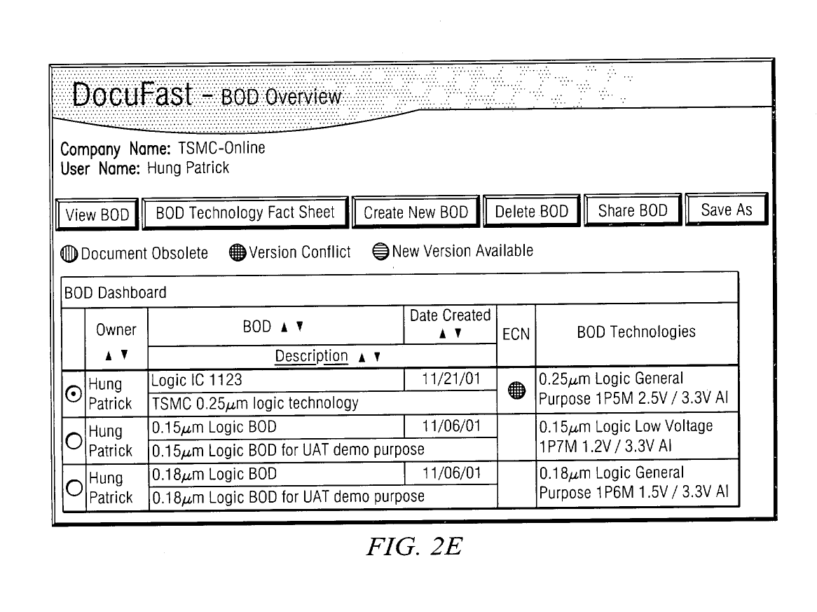

FIGS. 2A to 2E illustrate some preferred user interface allowing a customer/user to create a customized portfolio, i.e. a new BOD. The technology documents have been preliminary classified and stored in the document metadata database 110 according to different technologies, such as geometry levels and IC product characteristics. A preferred user interface is shown in FIG. 2A. To create a portfolio for a new product, one geometry level has to be chosen, such as 0.25 μm from 0.35 μm, 0.25 μm, 0.22 μm, 0.18 μm, 0.15 μm, or 0.13 μm from a geometry list. After that, a user interface appears, providing a list of various types of IC products as shown in FIG. 2B. Available IC product application, e.g. Logic, MS/RF, CIS, 1TRAM, or EmbFlash, and electrical characteristics can be chosen from the menu. Various key electrical characteristics of the chosen product are listed for further selection, as FIG. 2B shows.

After the technology-related geometry and product application are chosen, the preliminary technology definition is completed. The search engine of the management server 120 accesses the document database 110 according to the technology definition and lists all related technology documents. FIG. 2C shows a user interface listing all documents related to 0.25 μm Logic design with columns for document type, brief description, version status, and remarks. The designer can select required documents from the list and “Add to BOD” to save the new portfolio/BOD including the checked documents. As shown in FIG. 2D, the Web server 130 generates a window for assigning a filename and description of the customized portfolio/BOD. Preferably, the window also allows the user to choose whether to receive Engineering Change Notifications (ECN). The saved portfolio is then displayed as a control panel, as FIG. 2E shows, which lists all the portfolios the user can view. In addition, an authorized user can also delete an existing portfolio by selecting “delete BOD” in FIG. 2E.

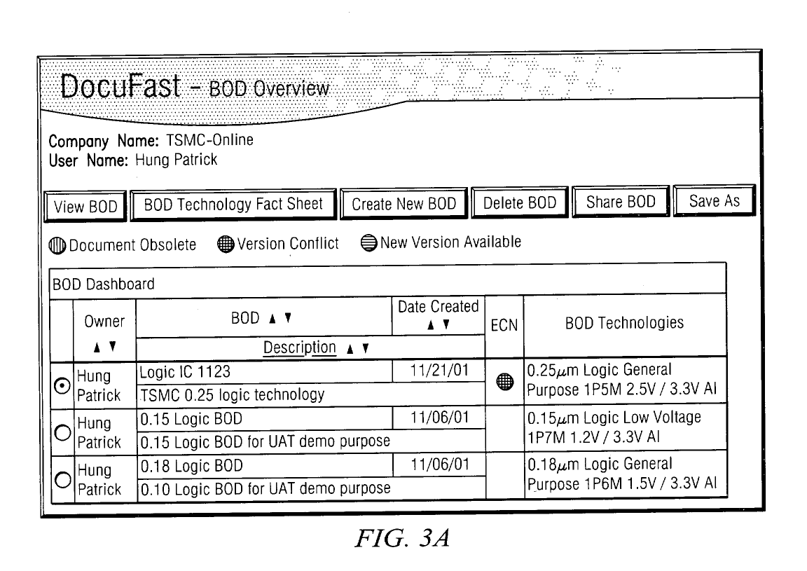

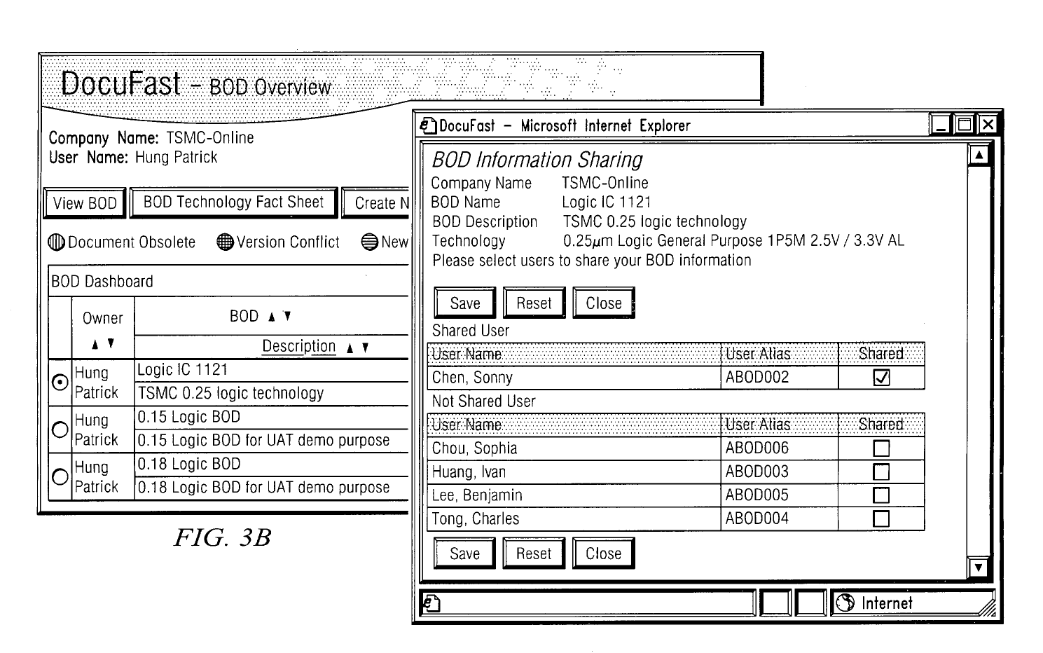

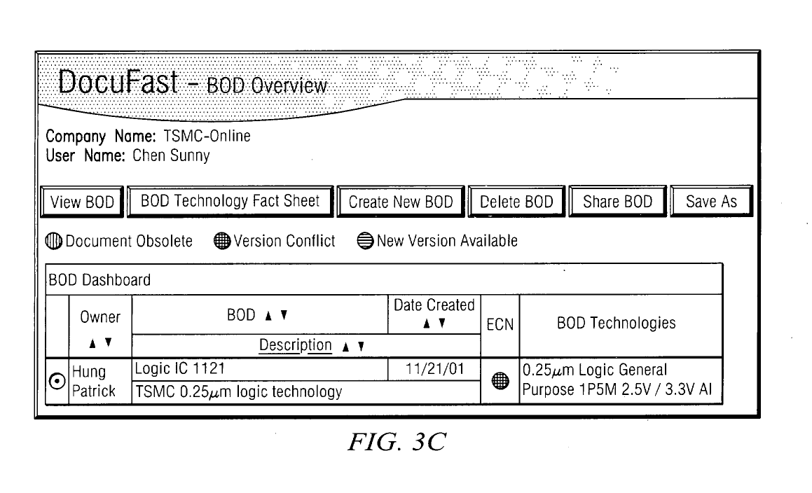

In a preferred embodiment, the website provides sharing of the portfolio. The sharing engine of the management server 120 allowing authorized users to share their portfolio with others, erg. team members. FIGS. 3A to 3C show a preferred user interface allowing sharing of a portfolio (BOD). A design company can provide a list of team members to the foundry so that, after building a portfolio (BOD) as shown in FIG. 3A, a designer can further select “share BOD”, generating a member list, as shown in FIG. 3B, and select members with which to share the portfolio. When a shared user logs onto the website, the user interface displays a control panel showing all shared portfolios for the user, as shown in FIG. 3C.

Preferably, the sharing engine of the management server 120 is programmed such that the shared users can only view shared portfolios, without update, delete, or add privileges.

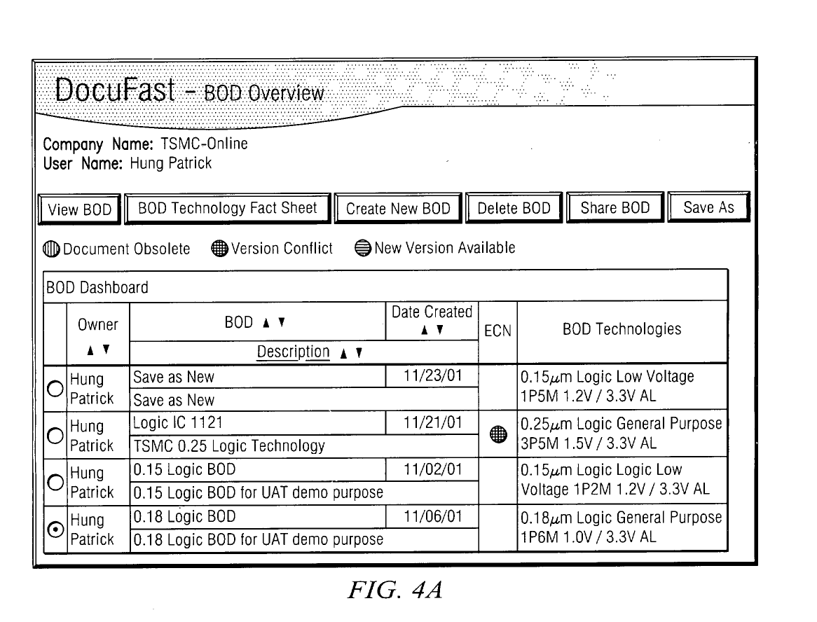

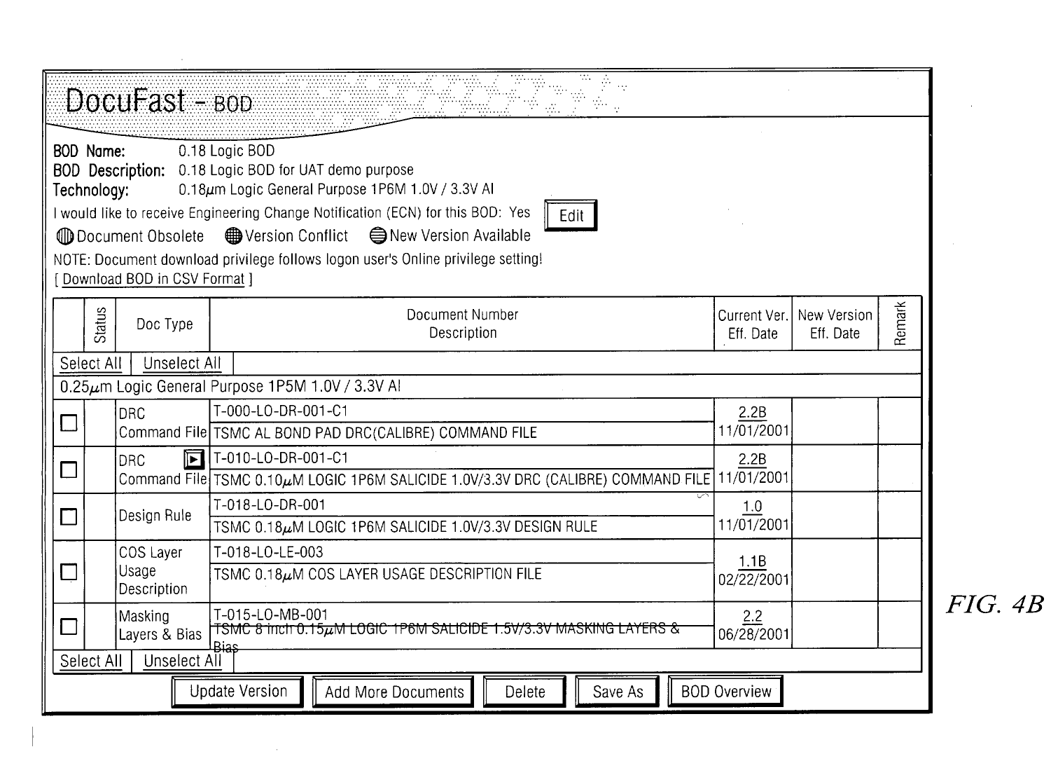

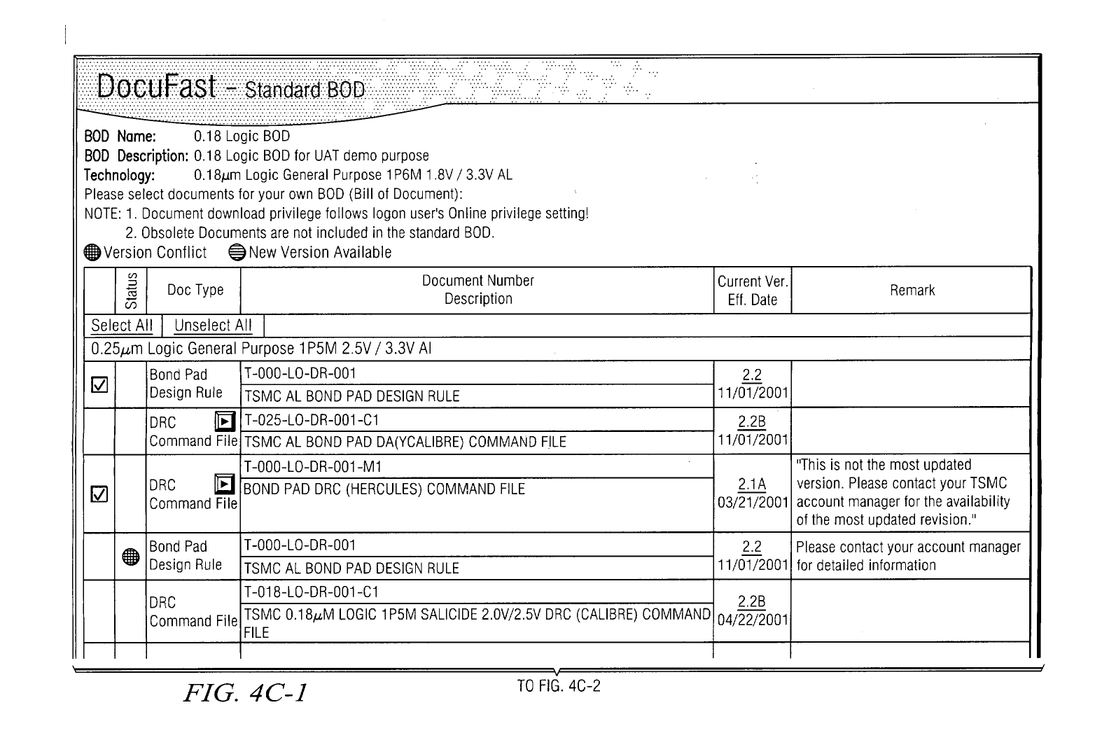

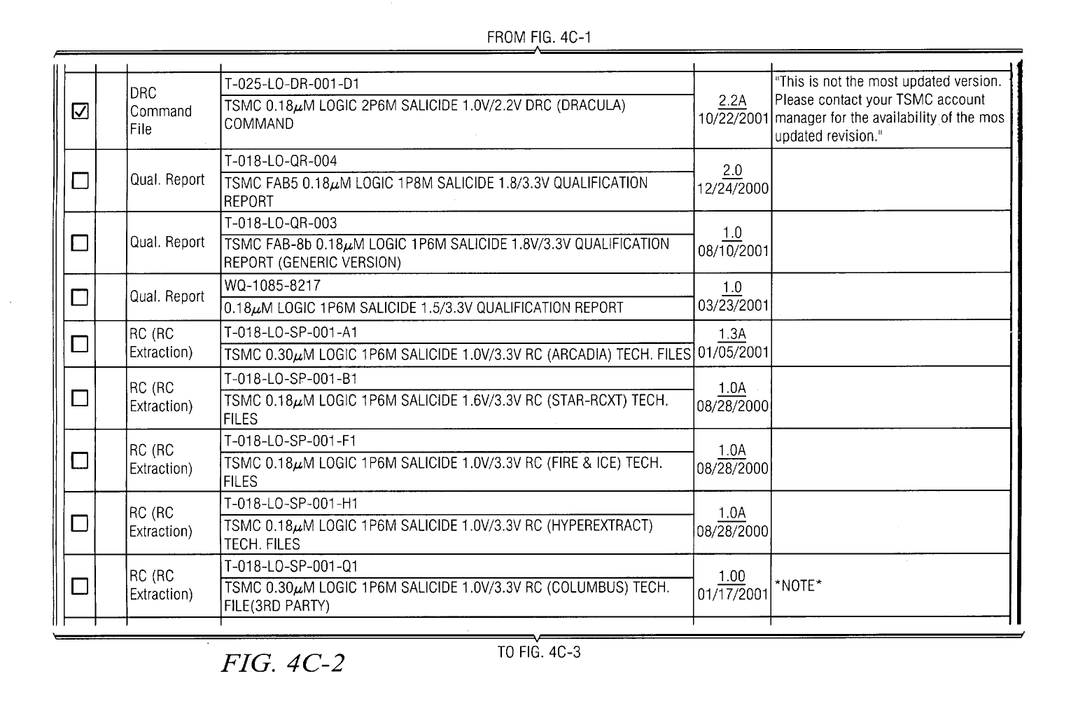

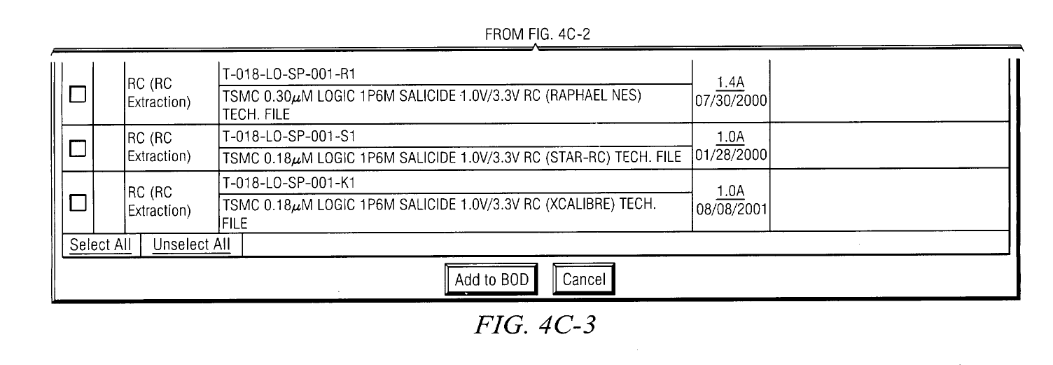

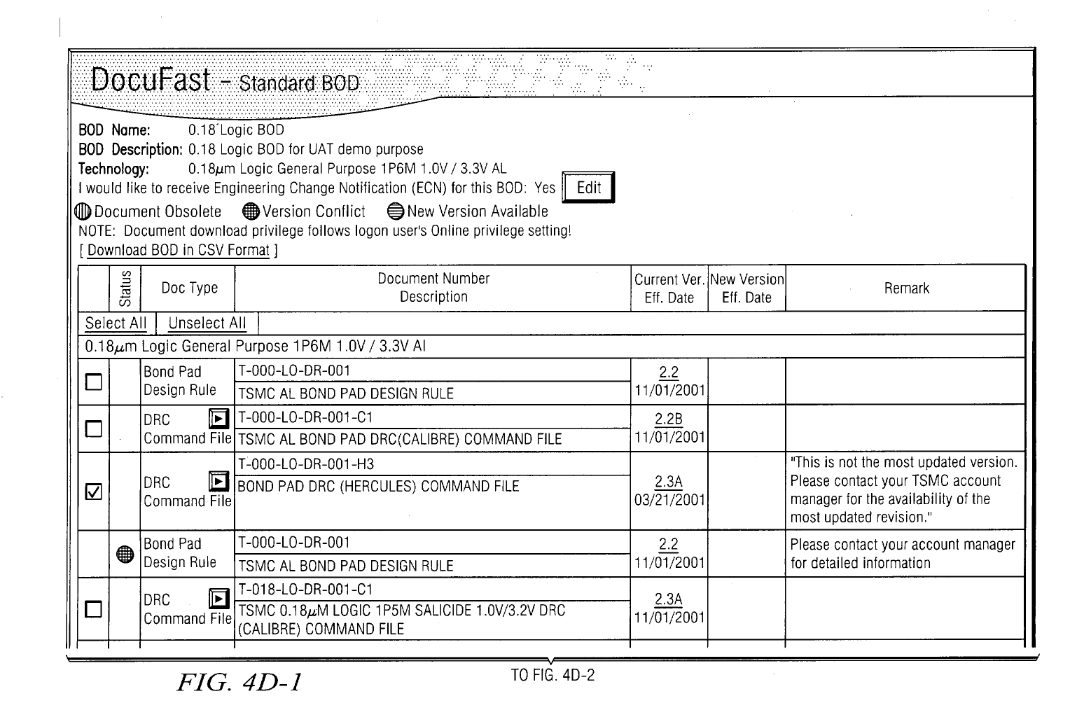

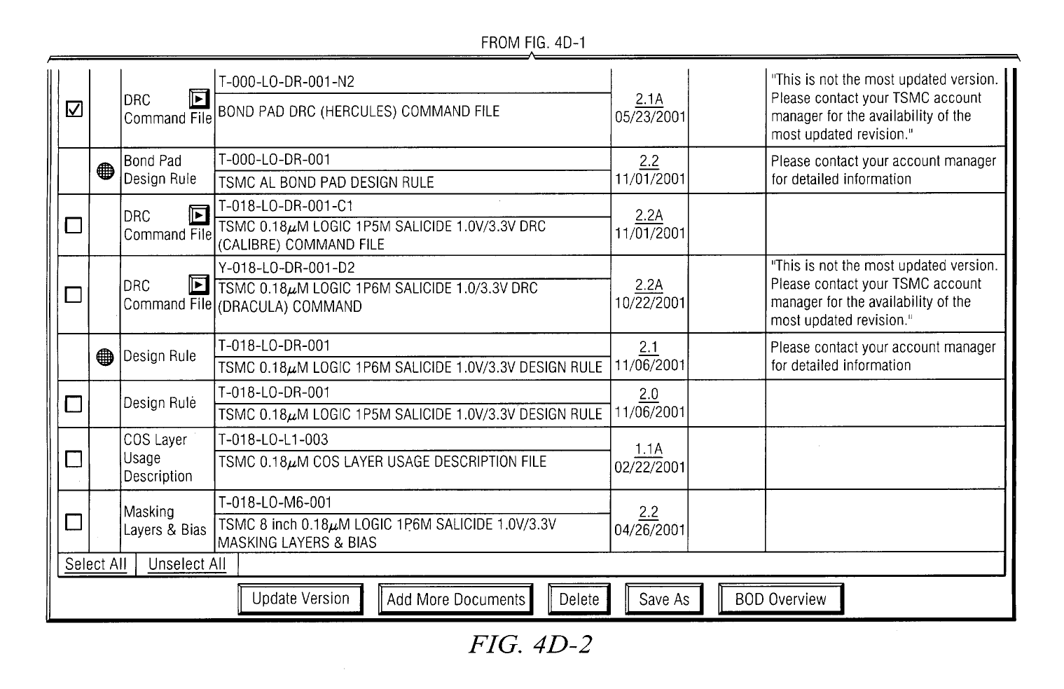

FIGS. 4A to 4D illustrate user interface provided by the customized portfolio system 100 to edit or manage the portfolio. As shown in FIG. 4A, one portfolio is selected, as is “View BOD”. The chosen portfolio is displayed as shown in FIG. 4B with all selected documents listed. Also shown are document types, document numbers, brief description, current, and new versions of documents in the portfolio, correspondingly.

As also shown in FIG. 4B, the customized portfolio system 100 allows only authorized users to add, delete, and update technology documents, but not shared users. When an authorized designer selects “Add More Documents”, a user interface as shown in FIG. 4C provides a list displaying unselected documents regarding the defined technology of the portfolio. Available documents are displayed with a check box allowing selection by authorized users. The authorized designer can check required documents and select “Add to BOD” to save the addition.

Accordingly, an authorized user can also select “Delete”, as shown in FIG. 4B, to delete documents from the portfolio. FIG. 4D shows available documents in the portfolio displayed with corresponding check boxes. An authorized user can check documents and select “Delete” button to effect the deletion. Authorized IC designers can easily maintain a customized portfolio regarding a new IC product via the interactive website provided by the Web Server 130.

Additionally, the customized portfolio system 100 provides engineering notification of document status changes. In a preferred embodiment, when a customized portfolio of certain technology documents has been created by an IC design team, the notification engine of the management server 120 monitors the version status of every document in the portfolio. When the selected version of a document in the portfolio is updated, the notification engine sends a notification to the owner, i.e. the design team, by means such as e-mail. The notification engine also provides a notification on the user interface when any authorized team member logs onto the website. The notification engine forwards the portfolio creator and the shared members a notification, e.g. via email, of document obsolescence, version conflict, or new version availability. Notifications are also preferably shown on the user interface with corresponding indicators when the users access portfolios online.

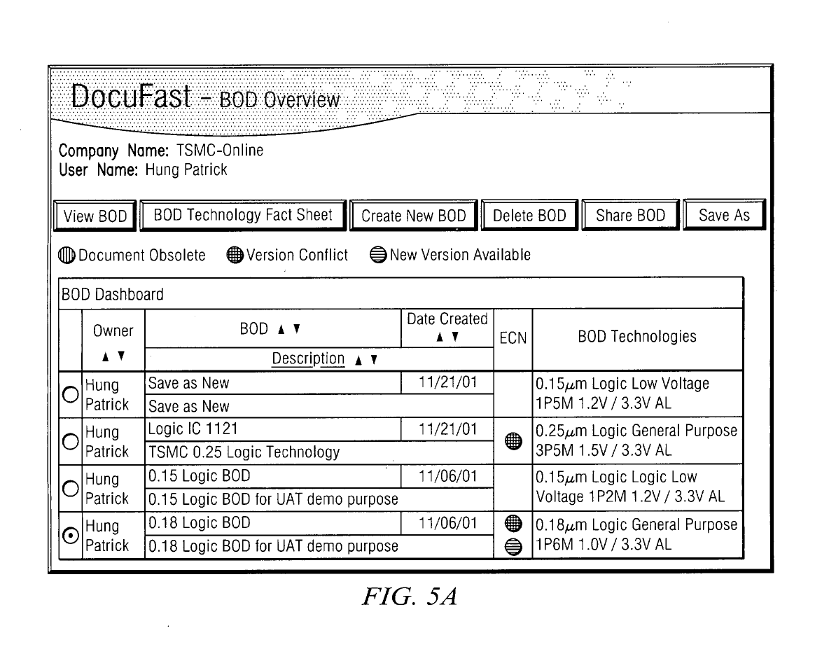

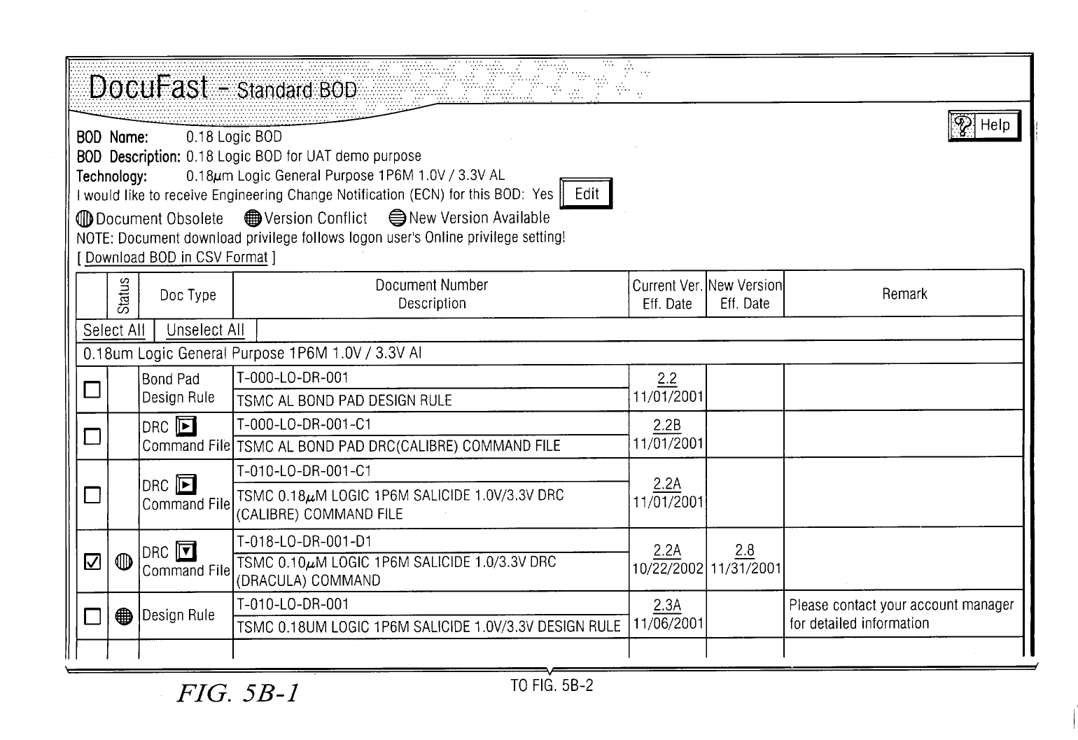

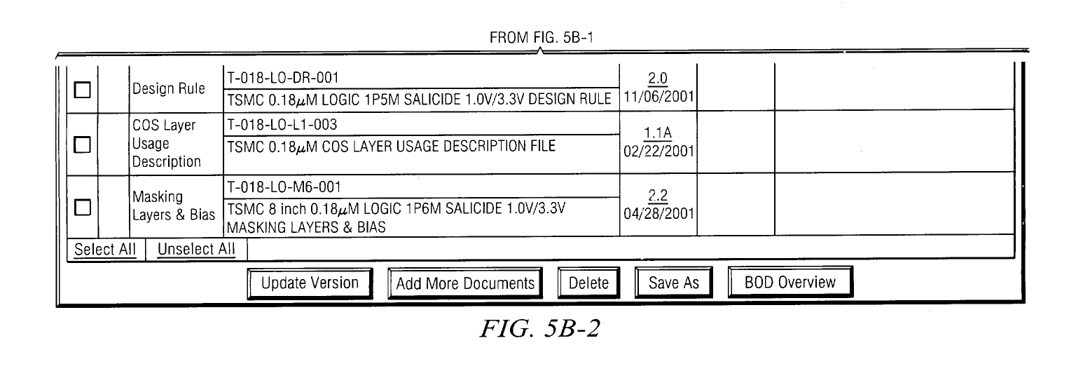

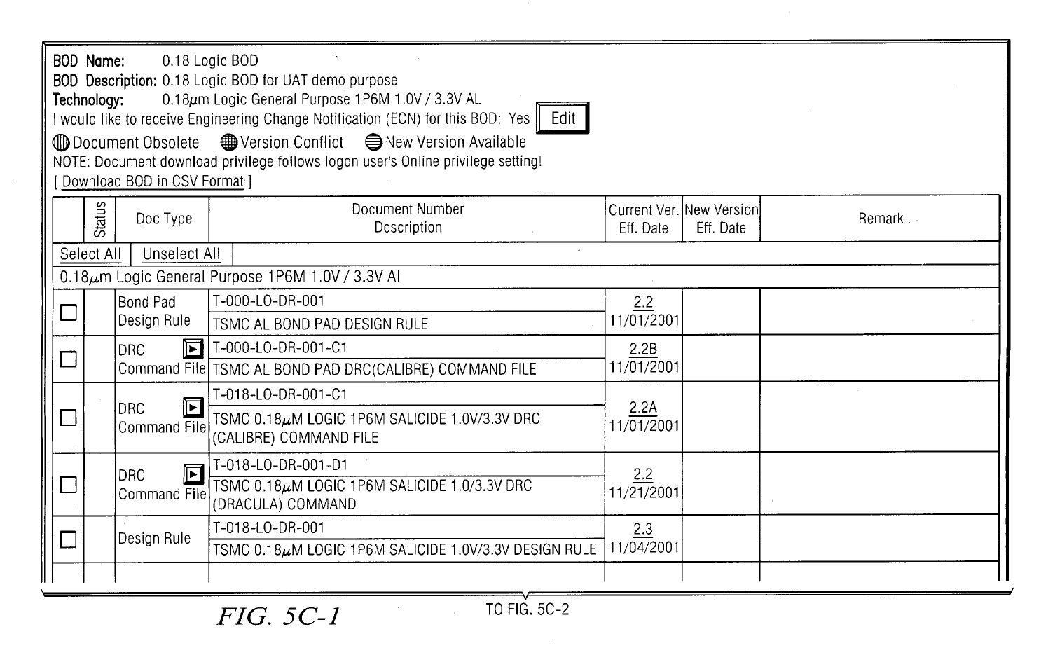

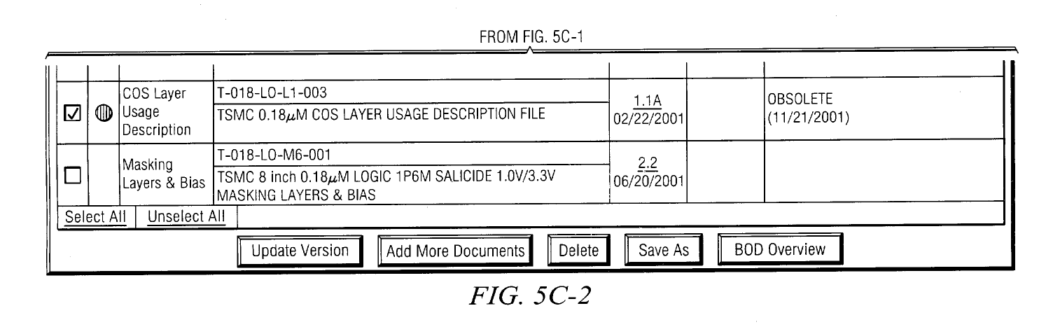

FIGS. 5A to 5C show preferred user interface for version monitoring and updating and document deleting. As shown in FIG. 5A, when a user logs onto the website, a list is displayed showing portfolios that the user can access. A column of notification, i.e. ECN, is displayed indicating visually the status of documents in each portfolio. In one embodiment, a blue light indicates a new version of a document is available. A yellow light indicates version conflict and a red light indicates that at least one document in the portfolio has been made obsolete by the foundry. Users easily recognize status changes. The details of document status can be viewed when the user selects a radio button of a portfolio on the list and “View BOD”.

As shown in FIG. 5B, the selected portfolio is displayed in detail with indicators representing document status. In FIG. 5B, a DRC command file is marked with a blue light indicator representing there is a new version of the DRC command file provided by the semiconductor foundry. The version number of the current and the new version are displayed respectively on the table. Preferably, remarks also briefly describe the version difference. The version can be updated by an authorized user. In FIG. 5B, an authorized user checks the check box of the document having a new version, and then selects “Update Version”. The management server 120 updates DRC command file in the portfolio to the latest version and the status column of the DRC command file is blank again.

As well, there is a design rule document with a yellow light indicator in FIG. 5B, representing version conflict. The “Design Rule” in FIG. 5B comprises a series of rules that relate to each other, however, when providing real-time information to the IC designer, the foundry may deliver a preliminary notice that there is a new document version not yet synchronized. The yellow light indicator thus warns designers that the document is now being updated, but is not yet complete. The designers can assess the impact to their design work beforehand.

Moreover, as shown in FIG. 5C, a red light indicator shows that a document has been made obsolete by the foundry. An authorized user can decide whether to keep the obsolete version. If not, selecting the check box of the document and then “Delete” allows the management server 120 to receive the command from the web server 130 to remove the obsolete document from the portfolio and disable the red light indicator.

Preferably, maintenance of the customized portfolio is performed only by authorized users via the website. Shared users can only receive notification e-mails and view the portfolio with indicator notification, with no add, delete, or update privileges. For a design team with several members, the key designer can manage the customized portfolio and the other shared members can view the status of the same portfolio without any modification rights.

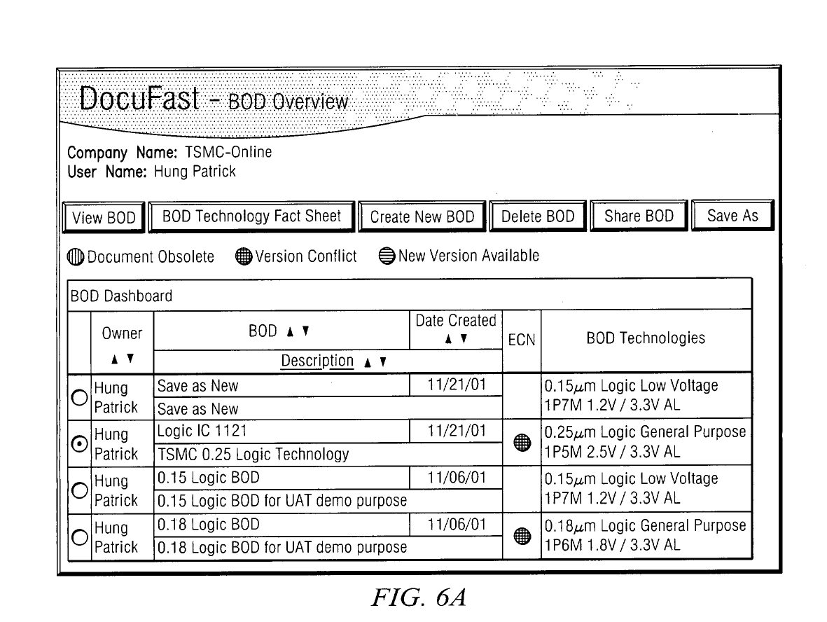

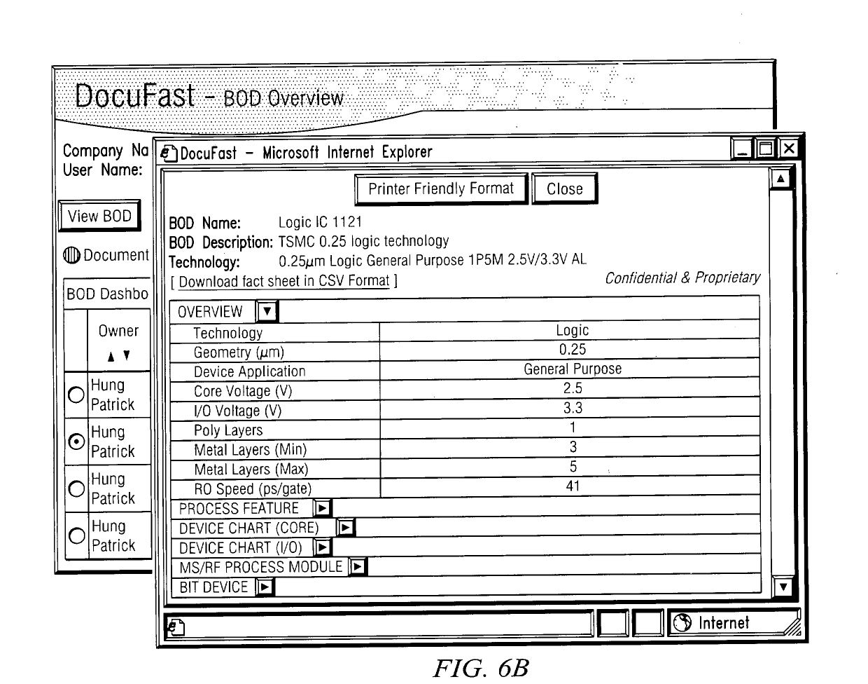

In a preferred embodiment, the website server 130 allows authorized users to download the fact sheet and/or document package of the portfolio. FIGS. 6A to 6C illustrate a preferred user interface allowing authorized users to download the fact sheet.

As FIG. 6A shows, an authorized user can select the radio button of a portfolio and then “BOD Technology Fact sheet”. Technology information for the selected portfolio, such as geometry, product type, product characteristics, is then displayed in a popup window as FIG. 6B shows. The user interface allows the user to print or download the fact sheet by selecting “Download Fact Sheet in CSV Format”. A window then allows the user to download the file or open it directly, as FIG. 6C shows.

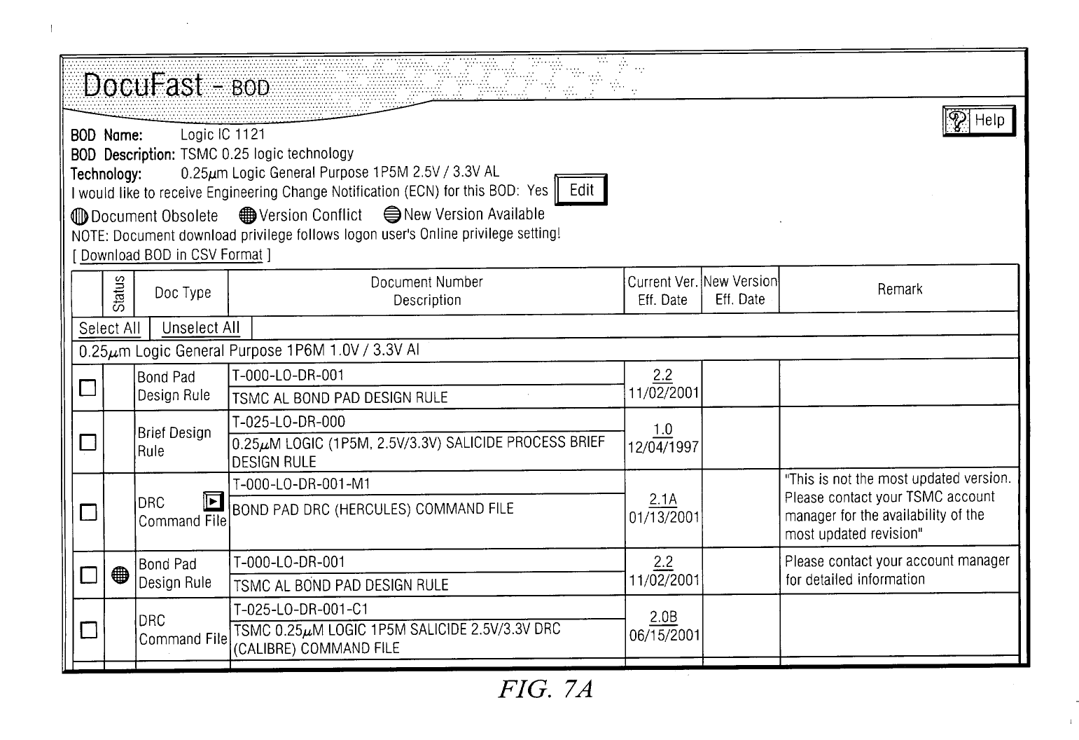

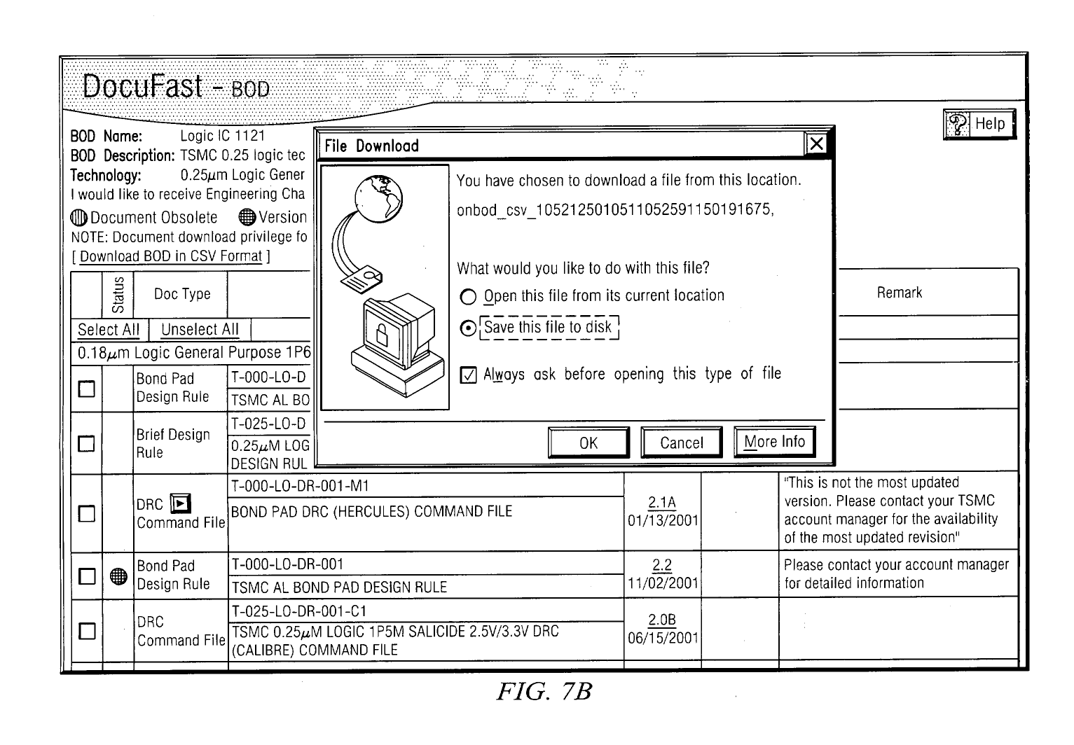

FIGS. 7A to 7C illustrate preferred user interface allowing authorized users to download the portfolio. An authorized user selects a portfolio and “View BOD”. The selected portfolio is then displayed as shown in FIG. 7A. The authorized user then selects “Download BOD in CSV format”, to download the portfolio. A window then allows the user to download the file or open it directly, as FIG. 7B shows.

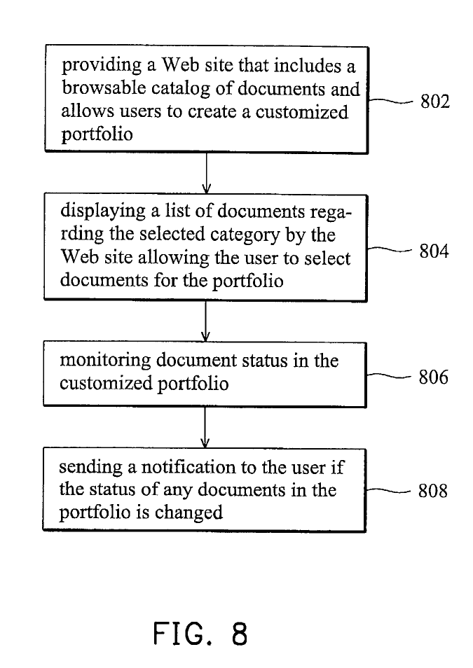

FIG. 8 illustrates a method flow providing customized portfolio management according to a preferred embodiment of the invention. A website is provided including a browsable catalog of documents classified by technology, allowing users to create a customized portfolio by selecting a technology in step 802. Preferably, the documents are technology documents provided by foundries regarding IC design. All technology documents are pre-classified based on fabrication geometry, such as 0.35 μm, 0.25 μm, 0.18 μm, 0.13 μm and so on, and product characteristics, such as logic, MS/RF, 1TRAM, EmbFlash, and so on.

A list of documents regarding the selected technology is displayed by the website, allowing a user to select documents for the customized portfolio in step 804.

Document status in the customized portfolio is monitored in step 806. In one embodiment, the notification engine as shown in FIG. 1 monitors the document database 110 for the status of the selected documents in the portfolio.

If the status of any documents in the portfolio changes, a notification is sent in step 808. Preferably, indicators on the website appear when the user logs onto the website to view changes. The indicators notify the user of document changes. In one embodiment, a blue light indicates that a new version has been provided by the foundry, a yellow light indicates incidence of version conflict, and a red light indicates that the document has been made obsolete by the foundry. Thus, the website allows the user to update versions and/or delete obsolete documents form the portfolio based on notification from the corresponding indicator lights. Authorized users can obtain more detail information of document status changes from remark column.

Accordingly, the above system and method flow provides IC designers with easy management and monitoring of foundry technology documents regarding their design by creating a customized portfolio. The service for customized portfolio management provided by the present invention saves design companies time and manpower of managing technology documents.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A customized portfolio management system, comprising:
a document metadata database storing a plurality of pre-classified documents and meta information thereof;
a management server programmed to a rule engine, a search engine, a security engine, and a notification engine; and
a web server providing an interactive website displaying the classified documents, allowing a terminal user to create a customized portfolio;
wherein the security engine authenticates user identification; the search engine searches the document metadata database according selection on the website to create the customized portfolio; the rule engine identifies document status in the document metadata database; and the notification engine monitors the status of the customized portfolio, sending notification when the status changes.

2. The system as claimed in claim 1, wherein the documents are technology documents regarding IC design provided by a foundry.

3. The system as claimed in claim 2, wherein the technology documents are classified based on fabrication geometry and electrical characteristics.

4. The system as claimed in claim 1, wherein the management server further allows the user to add and/or delete documents to or from the portfolio.

5. The system as claimed in claim 4, wherein the management server further provides a sharing engine allowing the user to share the customized portfolio with pre-defined authorized user privileges.

6. The system as claimed in claim 5, wherein the notification engine provides notification to the shared users when the status changes.

7. The system as claimed in claim 1, wherein the notification engine further provides indicators on the website showing the status change in portfolio documents.

8. The system as claimed in claim 7, wherein the indicators signify document updates, version conflicts and/or obsolescence.

9. The system as claimed in claim 8, wherein the indicators are indicator lights representing, by specific color-coding, version updates, version conflicts, and/or document obsolescences.

10. The system as claimed in claim 8, wherein the management server further allows the user to update the document with a new version.

11. The system as claimed in claim 8, wherein the management server further allows the user to delete obsolete documents from the portfolio.

12. A method for customized portfolio management, comprising the steps of:
providing a website that includes a browsable catalog of documents and allows a user to select a category;
displaying a list of documents on the website regarding the selected catalog, allowing the a user to select documents and create a customized portfolio;
monitoring document status in the customized portfolio; and
sending a notification when the status of any document in the portfolio is changed.

13. The method as claimed in claim 12, wherein the documents are technology documents regarding IC design provided by a foundry.

14. The method as claimed in claim 13, wherein the browsable catalog of documents is classified according to fabrication geometry and electrical characteristics.

15. The method as claimed in claim 13, further comprising a step of providing a share table by the website by which the user can share the customized portfolio with pre-defined authorized user privileges.

16. The method as claimed in claim 13, further comprising a step of providing a user interface on the website by which the user are allowed to add and/or delete documents to or from the portfolio.

17. The method as claimed in claim 13, further comprising providing indicators on the website indicating status changes in portfolio documents.

18. The method as claimed in claim 17, wherein the indicators show when documents have been updated or made obsolete, and/or version conflicts have occurred.

19. The method as claimed in claim 17, wherein the indicators are color-coded lights representing version updates, conflicts, and document obsolescence.

20. The method as claimed in claim 18, further comprising providing a user interface to update documents in the portfolio.

21. The method as claimed in claim 18, further comprising providing a user interface to delete obsolete documents from the portfolio.

22. A user interface for portfolio management comprising a page with at least:
a column listing at least one portfolio;
a notification column corresponding to each portfolio;
means for selecting one portfolio;
a button for displaying a selected portfolio;
wherein an indicator appears in the notification column when the status of a document in the portfolio has changed.

23. The user interface as claimed in claim 22, wherein the indicator is a light.

24. The user interface as claimed in claim 23, wherein the light indicator represents different status changes with different colors.

25. The user interface as claimed in claim 24, wherein the status change in documents comprises at least version update, version conflict and/or document obsolescence.

26. The user interface as claimed in claim 22, further comprising a subsequent page obtained by way of the button;
comprising a document list for the selected portfolio, a notification column corresponding to each document, and a plurality of buttons for editing the documents with an indicator displayed on the notification column when the status of a document in the portfolio has changed.

27. The user interface as claimed in claim 26, wherein the indicator in the subsequent page is a light.

28. The user interface as claimed in claim 27, wherein the light represents different status changes with different colors.

29. The user interface as claimed in claim 26, wherein the status changes for documents comprise at least version update, version conflict and/or document obsolescence.

30. The user interface as claimed in claim 22, wherein the document in the portfolio is a technology document regarding IC design, provided by a foundry.
